(19) United States
(12) Patent Application Publication
(10) Pub. No.: US 2017/0180131 A1
(43) Pub. Date: Jun. 22, 2017

(54) SECURE UNLOCK TO ACCESS DEBUG HARDWARE

(71) Applicant: Intel Corporation, Santa Clara, CA (US)

(72) Inventors: Santosh Ghosh, Hillsboro, OR (US); Manoj R. Sastry, Portland, OR (US); Solmaz Ghaznavi, Hillsboro, OR (US); Julien Carreno, El Dorado Hills, CA (US); Padraig J. Kearney, Dubline (IE)

(21) Appl. No.: 14/971,370

(22) Filed: Dec. 16, 2015

(51) Int. Cl. H04L 9/32; H04L 9/06; H04L 29/06

(52) U.S. Cl. CPC H04L 9/3239; H04L 63/061; H04L 63/123; H04L 9/0675

(57) ABSTRACT

System and techniques for secure unlock to access debug hardware are described herein. A cryptographic key may be received at a hardware debug access port of a device. A digest may be computed from the cryptographic key at an unlock unit of the device. A fuse value may be received from a non-volatile read-only storage on the device. The digest and the fuse value may be compared to determine whether they are the same. A pass-fail pulse may be provided that indicates the result of the comparing.

### TECHNICAL FIELD

Embodiments described herein generally relate to debug hardware, and more specifically to secure unlock to access debug hardware.

### BACKGROUND

Debug hardware often includes an access port to give debug devices access to underlying computer hardware to determine things like memory contents, cache utilization, execution stack, etc. These metrics may be used by a programmer to identify and fix problems with a program running on the computer hardware. Generally, the access port (e.g., debug port) conforms to a standard such as JTAG and provides access to devices (e.g., a memory management unit or processor) to the debugger.

Because debugging generally is able to access foundational structures in the computer hardware, it may be abused to, for example, inspect encrypted data after it is decrypted. Accordingly, some computer devices include security on the debug port of the computer hardware.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of component for secure unlock to access debug hardware, according to an embodiment.

FIG. 2 illustrates a block diagram of an example of an unlock engine for secure unlock to access debug hardware, according to an embodiment.

FIG. 3 illustrates a block diagram of an example of cryptographic digest hardware, according to an embodiment.

FIG. 4 illustrates a flow diagram of an example of a method for multi-factor intelligent agent control, according to an embodiment.

FIG. 5 is a block diagram illustrating an example of a machine upon which one or more embodiments may be implemented.

### DETAILED DESCRIPTION

To provide security for the debug port, a device may be manufactured or configured to store a key locally. The debugger would then provide the key to the debug port. The two keys (e.g., the provided key and the local key) are compared and, if they match, the debugger is permitted access to debugging functions. An issue with this approach arises when a manufacturer is at least somewhat outside the control of a vendor who provides the keys. For example, a contractor working overseas may have reason to, or lack of ability to refuse to, provide the keys to a third party, thus comprising the vendor's security keys.

A solution to the above identified issue may include adding cryptographic digest hardware to the computer device. Further, the stored value (e.g., fuse value), rather than being a key itself, may be a digest created from the key using the same mechanism employed by the cryptographic digest hardware. Thus, when the debugger seeks access to the debug port, the debugger provides the key, which is then converted by the cryptographic digest hardware into a digest, which is then compared to the fuse value. If the fuse value matches the computed digest, then access to the debugging functions is granted. Not only does this mechanism provide effective security for the computer hardware, but it also expands a company's potential manufacturing base, increasing efficiency. This may be additionally helpful in manufacturing many lost cost devices, such as many internet-of-things (IoT) devices.

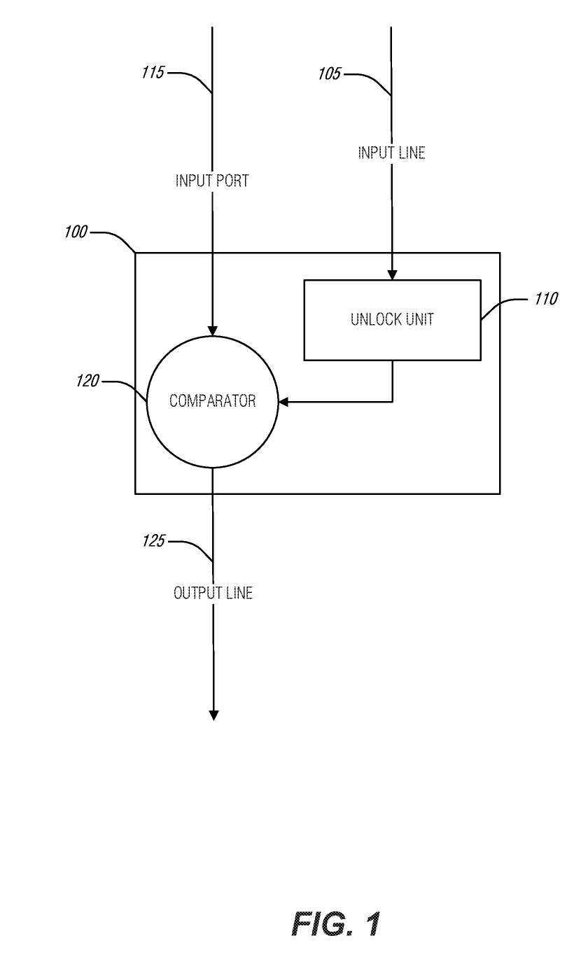

FIG. 1 is a block diagram of an example of component 100 for secure unlock to access debug hardware, according to an embodiment. The component 100 may include an input line 105, an input port 115, an unlock unit 110, a comparator 120, and an output line 125. The input line 105, output line 125, and the input port 115 are conductive connections (e.g., wires) and the unlock unit 110 and the comparator 120 are hardware implemented devices.

The input line 105 is arranged to receive a cryptographic key from a hardware debug access port of a device that includes the component 100. That is, the debug access port is not a virtual port or other software based port, but a physical connection to the debug circuitry. In an example, the input line 105 is directly connected to the unlock unit 110 to provide the cryptographic key to the unlock unit 110.

The unlock unit 110 is arranged to compute a digest from the cryptographic key. In an example, the hash is a SHA3 Keccak digest. It is understood that other cryptographic digests may similarly be employed. As described below, the unlock unit 110 may employ one or more state registers to compute the digest. In an example, the state registers both contain the digest as it is being iteratively computed as well as the next input portion of a message that is being turned into the digest. Thus, the entirety of the state registers does not translate to digest size, though they may be directly related. For example, to keep device counts (e.g., gates, etc.) lower for the unlock unit 110, the state registers may be sized to provide a particular digest size, such as 64 bits or 128 bits. In an example, the unlock unit 110 has a single state register. In an example, the state size of the unlock unit 100 is 200 bits. In this example, the 200 bits may be divided among bits for the ongoing digest (e.g., capacity) and bits to accept a next portion of the input message (e.g., bitrate). In an example, the 200 bits may be divided into a 128 bit capacity and 72 bit bitrate. As the output digest is generally half of the capacity, this configuration may yield a digest (and thus corresponding fuse value) of 64 bits. In an example, the state size of the unlock unit 100 is 400 bits. In an example, the 400 bits may be divided into a 256 bit capacity and 144 bit bitrate. As the output digest is generally half of the capacity, this configuration may yield a digest (and thus corresponding fuse value) of 128 bits.

In an example, to compute the digest, the unlock unit 110 is arranged to perform 18 rounds of operations when the digest is 64 bits and 20 rounds of operations when the digest is 128 bits. In an example, a round of the operations includes five operations: θ, ρ, π, χ, and ι, each of which is performed on the Keccak state variables. In an example, the unlock unit 110 is arranged to complete a round (e.g., all five operations) within one clock cycle. In an example, the unlock unit 110 includes a linear feed-back shift register (LFSR) counter to count the rounds.

The input port 115 is arranged to receive a fuse value. The fuse value is stored locally on the device in a secure location, such as read-only-memory, or other non-volatile storage devices. In an example, the storage device is read-only. The input port 115 may be directly connected to the comparator 120 to provide the fuse value. In an example, the input port 115 may hold the fuse value until a response_valid pulse is received. In an example, the input port 115 holds the fuse value at a comparator 120 signal, the response_valid pulse being received by the comparator 120.

The comparator 120 is arranged to compare the digest received from the unlock unit 110 to the fuse value received from the input port 115 to determine whether they are the same (e.g., match). In response to the determination, the comparator 120 is arranged to provide a pass-fail pulse (e.g., indication, signal, etc.) on the output line 125. That is, if the digest and the fuse value match, the comparator 120 will output a pass indication on the output line 125 and a fail indication otherwise. In an example, the pass-fail pulse occurs on the same clock cycle (e.g., tick, pulse, etc.) as a response_valid pulse is received by at least one of the comparator 120 or the input port 115.

By implementing a light-weight digest hardware component, devices, such as IoT devices may benefit from secure debug access without significantly increasing costs. Moreover, a vendor may provide the secure debug environment without exposing their own secret keys to a manufacturer. This may reduce consumer costs without sacrificing security on the finished device.

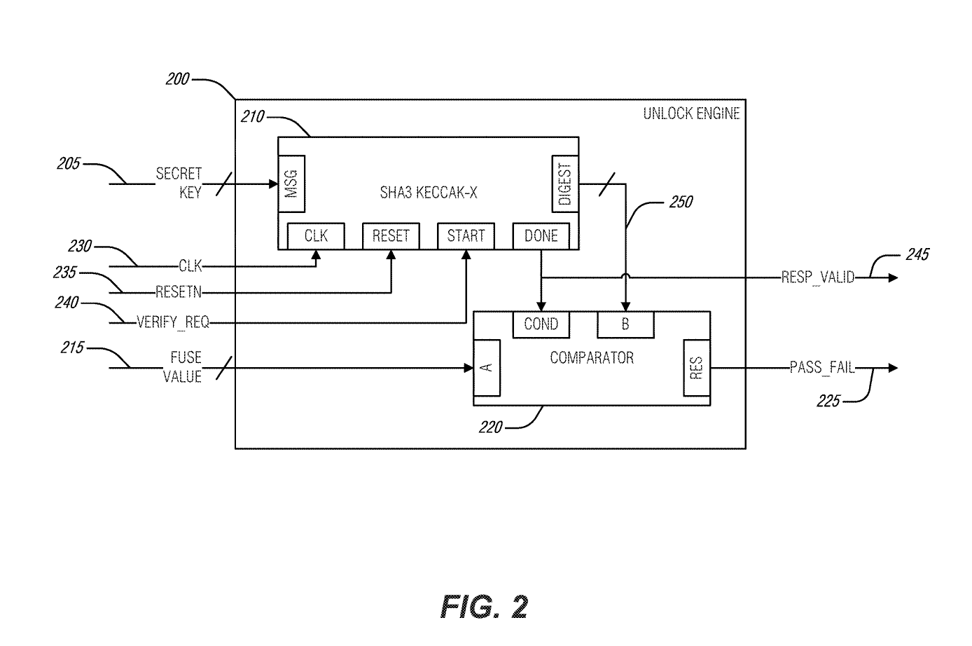

FIG. 2 illustrates a block diagram of an example of an unlock engine 200 for secure unlock to access debug hardware, according to an embodiment. The unlock engine 200 illustrates a particular top-level circuit arrangement for a device similar to the component 100 discussed above.

The unlock engine 200 which comprises two components: the Keccak SHA3Hash engine 210 and the comparator block 220. The illustrated interface of this engine 200 includes:
Inputs: vendor secret 205, fuse value 215, clock 230, resent 235 and verify_req 240
Outputs: pass_fail 225 and resp_valid 245.

The interface operates by applying a verify_req 240 pulse once the vendor's secret 205 and fuse value 215 (e.g., programmed digest) are available. The fuse value is held at an input port until resp_valid 245 pulse is provided by the Hash engine 210 when the digest 250 is ready. As noted above, in a configuration, the latency (e.g., time to compute the digest) of the engine is 18 or 20 clock cycles for 64-bit or 128-bit digests respectively.

The comparator block 220 compares the digest 250 with the fuse value 215 and generates pass_fail 225 in the same clock with resp_valid 245 pulse. The resp_valid 245 pulse also indicates that the value of pass_fail 225 output is valid only at that period (e.g., clock cycle). Thus, the pass_fail 225 may pulse prior to the resp_valid 245 pulse, but the output is not useful. The signal value of pass_fail 225 output may be a 1 to indicate pass and a 0 to indicate fail.

It is noted that, in this implementation, the comparator block 220 does not store the fuse value internally. This arrangement avoids a 64 bit or 128 bit register. It is also noted that the vendor's secret 205 is applied into the Keccak state register which is scrambled in each round. Thus, after execution the unlock engine 200 keeps no useable information about the secret 205, ensuring that the vendor's secret 205 remains a secret.

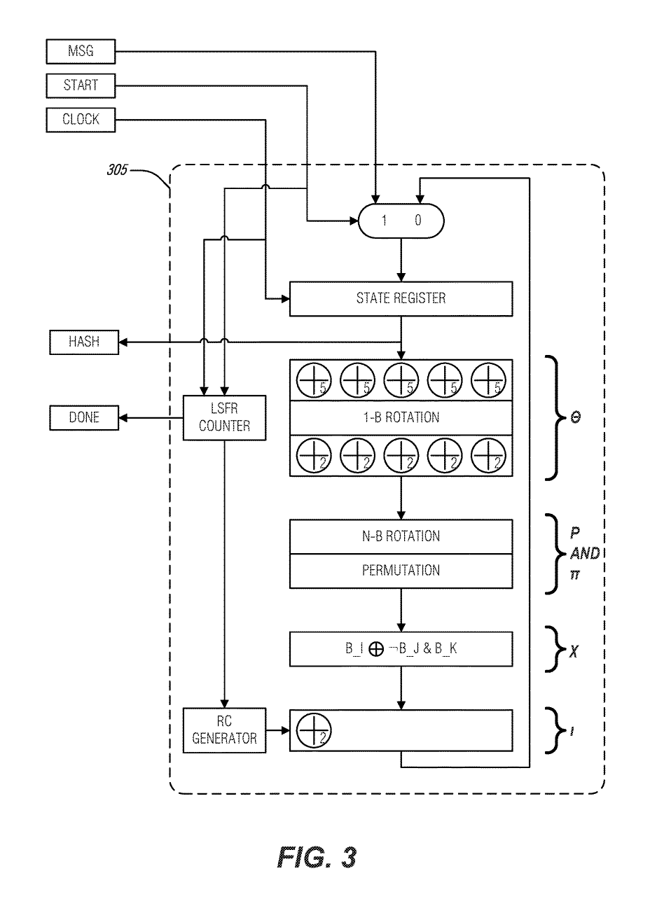

FIG. 3 illustrates a block diagram of an example of cryptographic digest hardware 305, according to an embodiment. Specifically, FIG. 3 illustrates an execution-based architecture of the SHA3 Keccak-X device described above in FIG. 2, where “X” is either 200 or 400, indicating the state size and thus the output digest size of 64 bits or 128 bits respectively. The execution hardware includes five sections, θ, ρ, π, χ and ι.

Although these sections of the Keccak operate on the state held in the state register. The state is held in a five by five matrix of words of some bit length (e.g., 32, 64, etc.). At θ, parity of the words in the five columns are individually computed and exclusive-ORed (XOR) into neighboring columns. At ρ, each of the 25 words are bitwise rotated by a different triangular number. At π, the 25 words are permuted with a fixed pattern. At χ, the bits are combined (e.g., bitwise combined) along rows. At ι, XOR a round constant (provided by the RC generator from the LSFR counter seed) into one word of the state.

When the allotted permutations are complete, the LSFR counter provides the done signal, at which point the hash is retrievable from the state register.

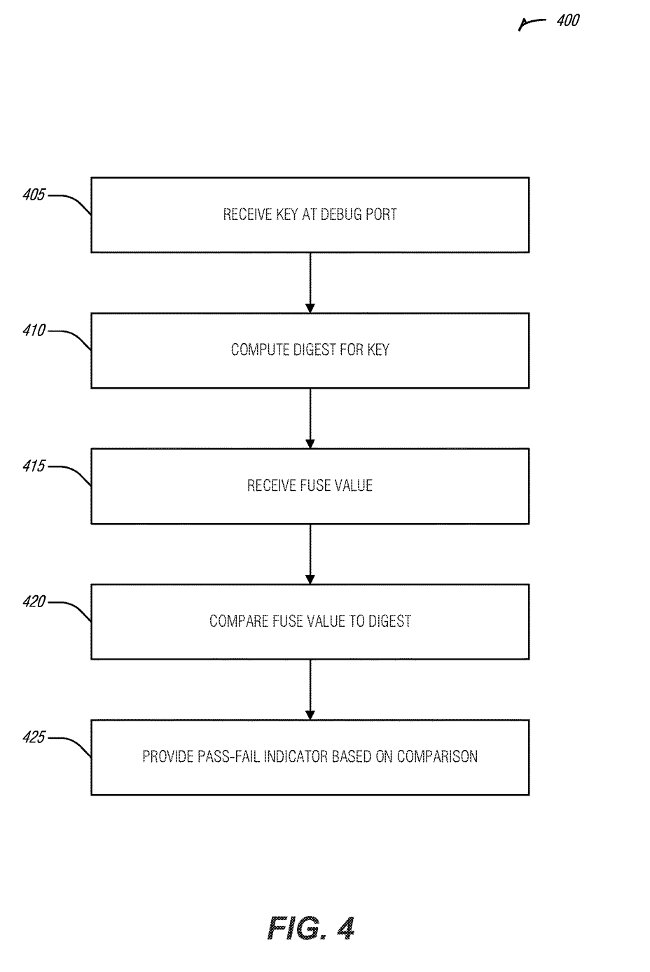

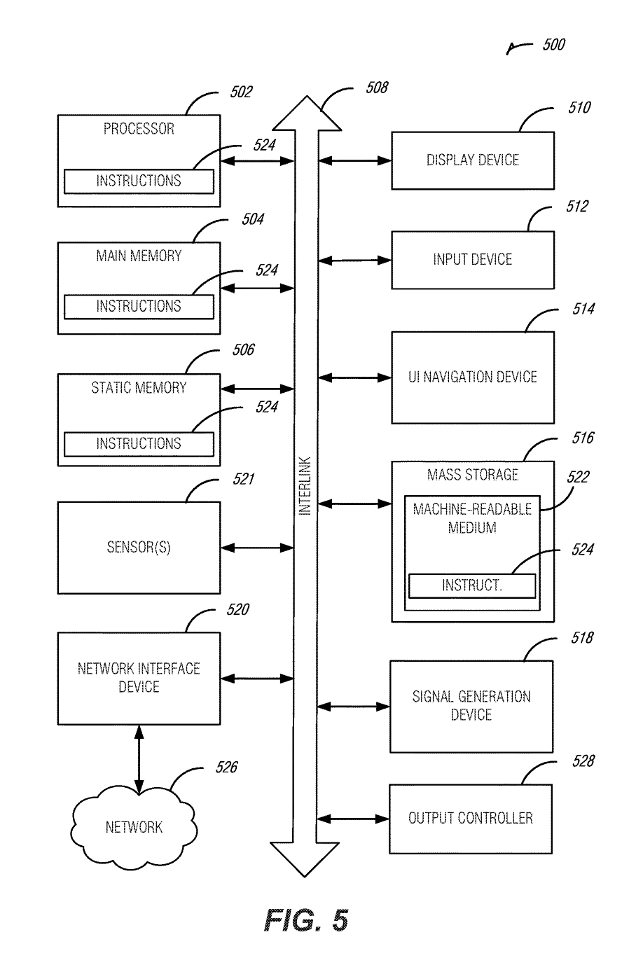

FIG. 4 illustrates a flow diagram of an example of a method 400 for multi-factor intelligent agent control, according to an embodiment. The operations of the method 400 are implemented in computer hardware, such as that described above with respect to FIGS. 1-3, or below with respect to FIG. 5 (e.g., circuit sets).

At operation 405, a cryptographic key is received at a hardware debug access port of a device.

At operation 410, a digest is computed from the cryptographic key at an unlock unit of the device. In an example, the digest is a SHA3 Keccak digest. In an example, a state size of the digest is 200, the capacity is 128, and the bit rate is 72. In an example, the cryptographic key and the fuse value are 64 bits. In an example, a state size of the digest is 400, the capacity is 256, and the bit rate is 144. In an example, the cryptographic key and the fuse value are 128 bits.

In an example, computing the digest includes performing 18 rounds of operations when the digest is 64 bits and 20 rounds of operations when the digest is 128 bits, In an example, a round of operations includes five operations. In an example, the round of operations is completed in a clock cycle. In an example, the rounds are counted with a linear feedback shift register counter. In an example, the digest is computed using a single state register.

At operation 415, a fuse value is received from a non-volatile read-only storage on the device. In an example, receiving the fuse value includes holding the fuse value at an input port to the comparator until the comparator receives a response valid pulse. In an example, the pass-fail pulse is provided with the response valid pulse on a clock cycle.

At operation 420, the digest and the fuse value are compared, by the comparator, to determine whether they are the same.

At operation 425, providing a pass-fail pulse indicating the result of the comparison, the pulse indicating pass when the digest value and the fuse value are the same and the pulse indicating fail otherwise.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES & EXAMPLES

Example 1 is a component for secure unlock to access debug hardware, the method comprising: an input line to receive a cryptographic key from a hardware debug access port of a device that includes the component; an unlock unit to compute a digest from the cryptographic key; an input port to receive a fuse value from a non-volatile read-only storage on the device; and a comparator to: compare the digest and the fuse value to determine whether they are the same; and provide a pass-fail pulse indicating the result of the compare, the pulse indicating pass when the digest value and the fuse value are the same and the pulse indicating fail otherwise.

In Example 2, the subject matter of Example 1 optionally includes wherein the digest is a SHA3 Keccak digest.

In Example 3, the subject matter of Example 2 optionally includes wherein a state size of the digest is 200, the capacity is 128, and the bit rate is 72.

In Example 4, the subject matter of Example 3 optionally includes wherein the cryptographic key and the fuse value are 64 bits.

In Example 5, the subject matter of any one or more of Examples 2-4 optionally include wherein a state size of the digest is 400, the capacity is 256, and the bit rate is 144.

In Example 6, the subject matter of Example 5 optionally includes wherein the cryptographic key and the fuse value are 128 bits.

In Example 7, the subject matter of any one or more of Examples 1-6 optionally include wherein to receive the fuse value includes the input port to hold the fuse value until the comparator receives a response valid pulse.

In Example 8, the subject matter of Example 7 optionally includes wherein the pass-fail pulse is provided with the response valid pulse on a clock cycle.

In Example 9, the subject matter of any one or more of Examples 1-8 optionally include wherein to compute the digest includes the unlock unit to perform 18 rounds of operations when the digest is 64 bits and 20 rounds of operations when the digest is 128 bits.

In Example 10, the subject matter of Example 9 optionally includes wherein a round of operations includes five operations.

In Example 11, the subject matter of Example 10 optionally includes wherein the round of operations is completed in a clock cycle.

In Example 12, the subject matter of any one or more of Examples 9-11 optionally include wherein the rounds are counted with a linear feedback shift register counter.

In Example 13, the subject matter of any one or more of Examples 1-12 optionally include wherein the digest is computed using a single state register.

Example 14 is a method for secure unlock to access debug hardware, the method comprising: receiving a cryptographic key at a hardware debug access port of a device; computing a digest from the cryptographic key at an unlock unit of the device; receiving a fuse value from a non-volatile read-only storage on the device; comparing, with a comparator, the digest and the fuse value to determine whether they are the same; and providing a pass-fail pulse indicating the result of the comparing, the pulse indicating pass when the digest value and the fuse value are the same and the pulse indicating fail otherwise.

In Example 15, the subject matter of Example 14 optionally includes wherein the digest is a SHA3 Keccak digest.

In Example 16, the subject matter of Example 15 optionally includes wherein a state size of the digest is 200, the capacity is 128, and the bit rate is 72.

In Example 17, the subject matter of Example 16 optionally includes wherein the cryptographic key and the fuse value are 64 bits.

In Example 18, the subject matter of any one or more of Examples 15-17 optionally include wherein a state size of the digest is 400, the capacity is 256, and the bit rate is 144.

In Example 19, the subject matter of Example 18 optionally includes wherein the cryptographic key and the fuse value are 128 bits.

In Example 20, the subject matter of any one or more of Examples 14-19 optionally include wherein receiving the fuse value includes holding the fuse value at an input port to the comparator until the comparator receives a response valid pulse.

In Example 21, the subject matter of Example 20 optionally includes wherein the pass-fail pulse is provided with the response valid pulse on a clock cycle.

In Example 22, the subject matter of any one or more of Examples 14-21 optionally include wherein computing the digest includes performing 18 rounds of operations when the digest is 64 bits and 20 rounds of operations when the digest is 128 bits.

In Example 23, the subject matter of Example 22 optionally includes wherein a round of operations includes five operations.

In Example 24, the subject matter of Example 23 optionally includes wherein the round of operations is completed in a clock cycle.

In Example 25, the subject matter of any one or more of Examples 22-24 optionally include wherein the rounds are counted with a linear feedback shift register counter.

In Example 26, the subject matter of any one or more of Examples 14-25 optionally include wherein the digest is computed using a single state register.

Example 27 is at least one machine readable medium including instructions that, when executed by a machine, cause the machine to perform any of methods 14-26.

Example 28 is a system including means to perform any of methods 14-26.

Example 29 is a system for secure unlock to access debug hardware, the system comprising: means for receiving a cryptographic key at a hardware debug access port of a device; means for computing a digest from the cryptographic key at an unlock unit of the device; means for receiving a fuse value from a non-volatile read-only storage on the device; means for comparing, with a comparator, the digest and the fuse value to determine whether they are the same; and means for providing a pass-fail pulse indicating the result of the comparing, the pulse indicating pass when the digest value and the fuse value are the same and the pulse indicating fail otherwise.

In Example 30, the subject matter of Example 29 optionally includes wherein the digest is a SHA3 Keccak digest.

In Example 31, the subject matter of Example 30 optionally includes wherein a state size of the digest is 200, the capacity is 128, and the bit rate is 72.

In Example 32, the subject matter of Example 31 optionally includes wherein the cryptographic key and the fuse value are 64 bits.

In Example 33, the subject matter of any one or more of Examples 30-32 optionally include wherein a state size of the digest is 400, the capacity is 256, and the bit rate is 144.

In Example 34, the subject matter of Example 33 optionally includes wherein the cryptographic key and the fuse value are 128 bits.

In Example 35, the subject matter of any one or more of Examples 29-34 optionally include wherein receiving the fuse value includes means for holding the fuse value at an input port to the comparator until the comparator receives a response valid pulse.

In Example 36, the subject matter of Example 35 optionally includes wherein the pass-fail pulse is provided with the response valid pulse on a clock cycle.

In Example 37, the subject matter of any one or more of Examples 29-36 optionally include wherein computing the digest includes means for performing 18 rounds of operations when the digest is 64 bits and 20 rounds of operations when the digest is 128 bits.

In Example 38, the subject matter of Example 37 optionally includes wherein a round of operations includes five operations.

In Example 39, the subject matter of Example 38 optionally includes wherein the round of operations is completed in a clock cycle.

In Example 40, the subject matter of any one or more of Examples 37-39 optionally include wherein the rounds are counted with a linear feedback shift register counter.

In Example 41, the subject matter of any one or more of Examples 29-40 optionally include wherein the digest is computed using a single state register.

Example 42 is at least one machine readable medium including instructions for secure unlock to access debug hardware, the instructions, when executed by a machine, cause the machine to perform operations comprising:

receiving a cryptographic key at a hardware debug access port of a device;
computing a digest from the cryptographic key at an unlock unit of the device;
receiving a fuse value from a non-volatile read-only storage on the device;
comparing, with a comparator, the digest and the fuse value to determine whether they are the same; and providing a pass-fail pulse indicating the result of the comparing, the pulse indicating pass when the digest value and the fuse value are the same and the pulse indicating fail otherwise.

In Example 43, the subject matter of Example 42 optionally includes wherein the digest is a SHA3 Keccak digest.

In Example 44, the subject matter of Example 43 optionally includes wherein a state size of the digest is 200, the capacity is 128, and the bit rate is 72.

In Example 45, the subject matter of Example 44 optionally includes wherein the cryptographic key and the fuse value are 64 bits.

In Example 46, the subject matter of any one or more of Examples 43-45 optionally include wherein a state size of the digest is 400, the capacity is 256, and the bit rate is 144.

In Example 47, the subject matter of Example 46 optionally includes wherein the cryptographic key and the fuse value are 128 bits.

In Example 48, the subject matter of any one or more of Examples 42-47 optionally include wherein receiving the fuse value includes holding the fuse value at an input port to the comparator until the comparator receives a response valid pulse.

In Example 49, the subject matter of Example 48 optionally includes wherein the pass-fail pulse is provided with the response valid pulse on a clock cycle.

In Example 50, the subject matter of any one or more of Examples 42-49 optionally include wherein computing the digest includes performing 18 rounds of operations when the digest is 64 bits and 20 rounds of operations when the digest is 128 bits.

In Example 51, the subject matter of Example 50 optionally includes wherein a round of operations includes five operations.

In Example 52, the subject matter of Example 51 optionally includes wherein the round of operations is completed in a clock cycle.

In Example 53, the subject matter of any one or more of Examples 50-52 optionally include wherein the rounds are counted with a linear feedback shift register counter.

In Example 54, the subject matter of any one or more of Examples 42-53 optionally include wherein the digest is computed using a single state register.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A component for secure unlock to access debug hardware, the method comprising:
an input line to receive a cryptographic key from a hardware debug access port of a device that includes the component;
an unlock unit to compute a digest from the cryptographic key;
an input port to receive a fuse value from a non-volatile read-only storage on the device; and
a comparator to:
compare the digest and the fuse value to determine whether they are the same; and
provide a pass-fail pulse indicating the result of the compare, the pulse indicating pass when the digest value and the fuse value are the same and the pulse indicating fail otherwise.

2. The component of claim 1, wherein the digest is a SHA3 Keccak digest.

3. The component of claim 1, wherein to receive the fuse value includes the input port to hold the fuse value until the comparator receives a response valid pulse.

4. The component of claim 3, wherein the pass-fail pulse is provided with the response valid pulse on a clock cycle.

5. The component of claim 1, wherein to compute the digest includes the unlock unit to perform 18 rounds of operations when the digest is 64 bits and 20 rounds of operations when the digest is 128 bits.

6. The component of claim 5, wherein a round of operations includes five operations.

7. The component of claim 6, wherein the round of operations is completed in a clock cycle.

8. The component of claim 1, wherein the digest is computed using a single state register.

9. A method for secure unlock to access debug hardware, the method comprising:
receiving a cryptographic key at a hardware debug access port of a device;
computing a digest from the cryptographic key at an unlock unit of the device;
receiving a fuse value from a non-volatile read-only storage on the device;
comparing, with a comparator, the digest and the fuse value to determine whether they are the same; and
providing a pass-fail pulse indicating the result of the comparing, the pulse indicating pass when the digest value and the fuse value are the same and the pulse indicating fail otherwise.

10. The method of claim 9, wherein the digest is a SHA3 Keccak digest.

11. The method of claim 9, wherein receiving the fuse value includes holding the fuse value at an input port to the comparator until the comparator receives a response valid pulse.

12. The method of claim 11, wherein the pass-fail pulse is provided with the response valid pulse on a clock cycle.

13. The method of claim 9, wherein computing the digest includes performing 18 rounds of operations when the digest is 64 bits and 20 rounds of operations when the digest is 128 bits.

14. The method of claim 13, wherein a round of operations includes five operations.

15. The method of claim 14, wherein the round of operations is completed in a clock cycle.

16. The method of claim 9, wherein the digest is computed using a single state register.

17. At least one machine readable medium including instructions for secure unlock to access debug hardware, the instructions, when executed by a machine, cause the machine to perform operations comprising:
receiving a cryptographic key at a hardware debug access port of a device;
computing a digest from the cryptographic key at an unlock unit of the device;
receiving a fuse value from a non-volatile read-only storage on the device;
comparing, with a comparator, the digest and the fuse value to determine whether they are the same; and
providing a pass-fail pulse indicating the result of the comparing, the pulse indicating pass when the digest value and the fuse value are the same and the pulse indicating fail otherwise.

18. The machine readable medium of claim 17, wherein the digest is a SHA3 Keccak digest.

19. The machine readable medium of claim 17, wherein receiving the fuse value includes holding the fuse value at an input port to the comparator until the comparator receives a response valid pulse.

20. The machine readable medium of claim 19, wherein the pass-fail pulse is provided with the response valid pulse on a clock cycle.

21. The machine readable medium of claim 17, wherein computing the digest includes performing 18 rounds of operations when the digest is 64 bits and 20 rounds of operations when the digest is 128 bits.

22. The machine readable medium of claim 21, wherein a round of operations includes five operations.

23. The machine readable medium of claim 22, wherein the round of operations is completed in a clock cycle.

24. The machine readable medium of claim 17, wherein the digest is computed using a single state register.
